(19) United States
(12) Patent Application Publication
(10) Pub. No.: US 2016/0059746 A1
(43) Pub. Date: Mar. 3, 2016

(54) Adjustable Foot For A Child Car Seat Base

(71) Applicant: Goodbaby Child Product Co., Ltd., Kunshan City (CN)

(72) Inventors: Mark Brian Finnestad, Franklin, MA (US); William Martin, Ashland, MA (US); Feng Bo, Kunshan City (CN)

(21) Appl. No.: 14/797,265

(22) Filed: Jul. 13, 2015

Related U.S. Application Data
(60) Provisional application No. 62/042,827, filed on Aug. 28, 2014.

(51) Int. Cl. B60N 2/28

(52) U.S. Cl. CPC B60N 2/2821; B60N 2/2866

(57) ABSTRACT

In one embodiment, a base for a child safety seat can comprise a base plate having a top surface for receiving a child car seat and a bottom surface adapted to face towards a vehicle seat. A height adjustment assembly can comprise an actuator, a shaft having a first end attached to the actuator, and a retaining member disposed on the shaft. An adjustable foot adapted to be disposed in the cavity can comprise a locking member on an inner surface. The shaft can have a locked position, wherein the retaining member extends from the shaft and cooperates with the locking member to hold the adjustable foot in a first height position, and an unlocked position, where the retaining member retracts from the locking member to allow free movement of the adjustable foot.

The present application claims priority to U.S. Provisional Patent Application Ser. No. 62/042,827 for “Adjustable Foot for an Infant Car Seat Base”, filed Aug. 28, 2014, the disclosure of which is incorporated herein by reference.

### FIELD OF THE DISCLOSURE

The present disclosure generally relates to infant and child safety systems for use in passenger vehicles. Specifically, the present disclosure relates to an adjustable foot integrated into a car seat base.

### BACKGROUND

Child restraint systems are well known in the art, and are designed to protect children from injury or death during collisions. The design of child restraint systems typically varies depending on the age and size of the child. For example, children under 4 feet, 9 inches tall may require the use of a simple booster seat until they are large enough to use an adult seat belt. Infant or child safety seats typically have more components, and place an infant or child in a rearward-facing, semi-recumbent position.

Typically, a child safety seat is made up of two parts: a car seat carrier, and a base into which the car seat carrier is mounted. The base is positioned on the seat of a vehicle, such as a car, truck, train, or airplane, and secured using either the passenger restraint system of the vehicle or another form of tethering system. For example, a base is typically secured in place on an automobile seat through the use of the vehicle's seat belt or a LATCH (Lower Anchors and Tethers for CHildren) system.

The car seat carrier is then attached to the base, typically using one or more connection points. This allows the base to be left secured to the vehicle seat, while only the carrier is removed. To provide maximum protection to the infant, the carrier is typically oriented such that when the infant is properly placed in the carrier, the infant's feet are nearest the seat back.

There are a number of issues associated with each of these two components. One such issue is the variation in slope and position of the vehicle seat onto which the base is placed. For example, some vehicle seats are horizontal, or nearly horizontal. Others, however, are more sloped. Typically, the inner portion of the seat, where it meets the seat back, will be at a lower height than the outer portion of the seat, where the user's legs hang from. Therefore, the base, unless it has an adjustment, is positioned at different inclinations based on the vehicle's seat. These differences in inclination cause the child safety seat to also be at different inclinations, some of which may not offer sufficient protection and comfort for the child. Height adjustments within the base can be used to minimize this issue.

Currently, some of these issues are addressed in a variety of ways, with varying degrees of success. In some cases, the solutions to these issues are expensive, thereby raising the price of the child safety seat. It would be beneficial if these issues could be addressed in a safe, convenient and cost effective manner.

### SUMMARY

The problems of the prior art are addressed by a novel child safety seat system comprising an adjustable foot in a car seat base. The base comprises a height adjustment to allow the base to assume one of a plurality of positions and inclinations when mounted to the vehicle seat. Certain embodiments can comprise a shaft that is configured to translate longitudinal movement into lateral movement of a retaining member, which is used to releasably engage an adjustable foot disposed in the base.

In one embodiment, a base for a child safety seat comprises a base plate having a top surface and a bottom surface, the top surface configured to receive a car seat and the bottom surface adapted to face toward a vehicle seat. A cavity can be disposed in the bottom surface. The base can further comprise a height adjustment assembly, which can comprise an actuator, a shaft having a first end attached to the actuator, and a retaining member disposed on the shaft. An adjustable foot is disposed within the cavity and has a locking member on an inner surface. The shaft has a locked position, wherein the retaining member extends from the shaft and cooperates with the locking member to hold the adjustable foot in a first height position, and an unlocked position where the retaining member retracts from the locking member, thus allowing free movement of the adjustable foot. In certain embodiments, the actuator may be accessible from the top surface of the base plate. In certain embodiments, the base can further comprise one or more additional locking members disposed on the inner surface, wherein the one or more additional locking members allow the adjustable foot to be held in a variety of height positions. In certain embodiments, the base can comprise one or more additional retaining members disposed on the shaft, such that the one or more additional retaining members allow the adjustable foot to be held in a variety of height positions. In certain embodiments, the base can further comprise a biasing member in communication with the retaining member, wherein the biasing member is configured to bias the shaft to the locked position. In certain embodiments, the retaining member can comprise a pin, and the locking member can comprise a recess configured to receive the pin.

In another embodiment, a base for a child safety seat, comprises a base plate having an upper surface configured to securely receive a car seat carrier and a lower surface adapted to be positioned on a vehicle seat. A shaft is positioned within the base and in communication with a retaining member. The base is configured to translate longitudinal movement of the shaft into lateral movement of the retaining member. A foot is disposed on the lower surface. The foot is releasably engaged by lateral movement of the retaining member. In certain embodiments, the lower surface can further comprise a cavity, and the foot is at least partially disposed within the cavity. In certain embodiments, the foot can be configured to move longitudinally to adjust the height of the base with respect to the seat of the vehicle. In certain embodiments, the foot can be in contact with the vehicle seat. In certain embodiments, the base can further comprise an actuator disposed on the upper surface, wherein the actuator is in communication with the shaft. In these embodiments, the base can be configured to translate longitudinal movement of the actuator into lateral movement of the retaining member. In certain embodiments, the foot can further comprise a locking member, wherein lateral movement of the retaining member secures the foot by engaging with the locking member. In certain embodiments, the retaining member can comprise a locking pin in communication with an alignment pin, and the base can further comprise a diagonal slot, wherein the base is configured to translate longitudinal movement of the shaft into lateral movement of the retaining member by tracking the alignment pin within the diagonal slot. In certain embodiments, the retaining member is biased towards engagement with the foot. In still further embodiments, the foot can be pivotally attached to the lower surface of the base.

In another embodiment, a base for a child safety seat, adapted to be mounted in a vehicle seat, comprises a base plate having a top surface and a bottom surface, the top surface configured to receive a car seat carrier and the bottom surface adapted to face toward the vehicle seat, the bottom surface further comprising a cavity. The base can further comprise a height adjustment assembly, which can include an actuator, a shaft having a first end attached to the actuator, and a retaining member disposed on the shaft. An adjustable foot can be disposed within the cavity and includes a locking member. The shaft can have a locked position, wherein the retaining member cooperates with the locking member to hold the adjustable foot in a first height position, and an unlocked position wherein the retaining member retracts from the locking member to allow free movement of the adjustable foot. Further, the base can be configured to translate longitudinal movement of the shaft into lateral movement lateral movement of the retaining member. In certain embodiments, the retaining member can comprise a plurality of retaining members. In still further embodiments, the locking member can comprise a plurality of locking members.

### BRIEF DESCRIPTION OF THE DRAWINGS

For a better understanding of the present disclosure, reference is made to the accompanying drawings, which are incorporated herein by reference and in which:

FIGS. 1A-B are perspective top and bottom views, respectively, of a base of a child safety seat according to one embodiment of the disclosure;

FIG. 2 is a cross-sectional view of the base along line A-A′ of FIG. 1A and illustrates a height adjustment assembly according to one embodiment of the disclosure;

FIG. 3 is a perspective view of a locking pin housing separated from the height adjustment assembly of FIG. 2;

FIG. 4 is a perspective view of the height adjustment assembly of FIG. 2 in the locked position;

FIG. 5 is a perspective view of the height adjustment assembly of FIG. 2 in the unlocked position;

FIG. 6 is a cross-sectional view of an adjustable foot according to one embodiment of the disclosure;

FIG. 7 is a perspective view of the adjustable foot of FIG. 6; and

FIG. 8 is a perspective view of another embodiment of a height adjustment assembly according to the disclosure.

### DETAILED DESCRIPTION

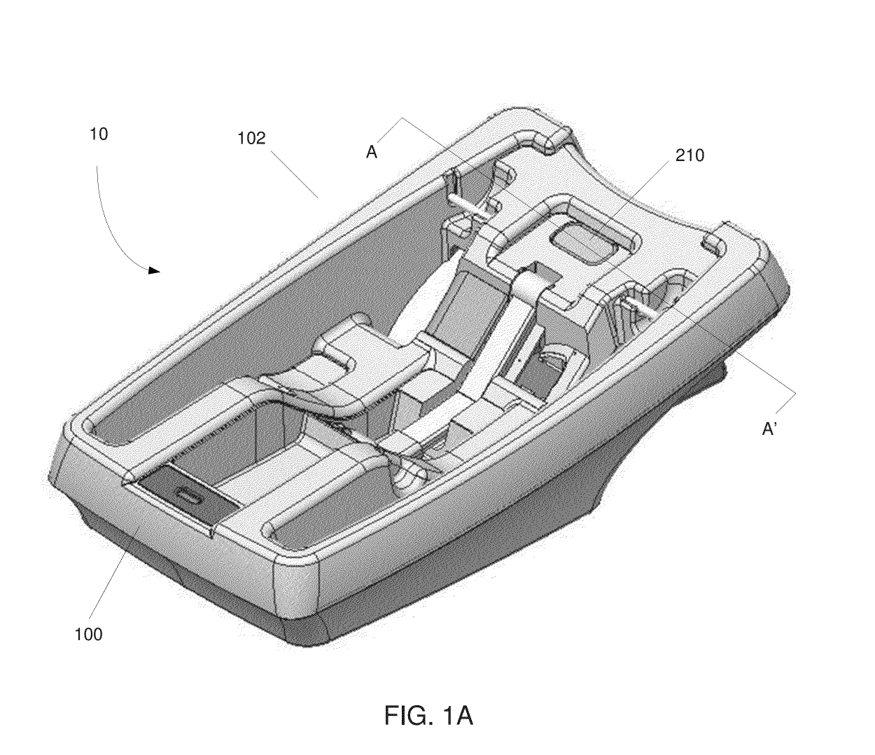

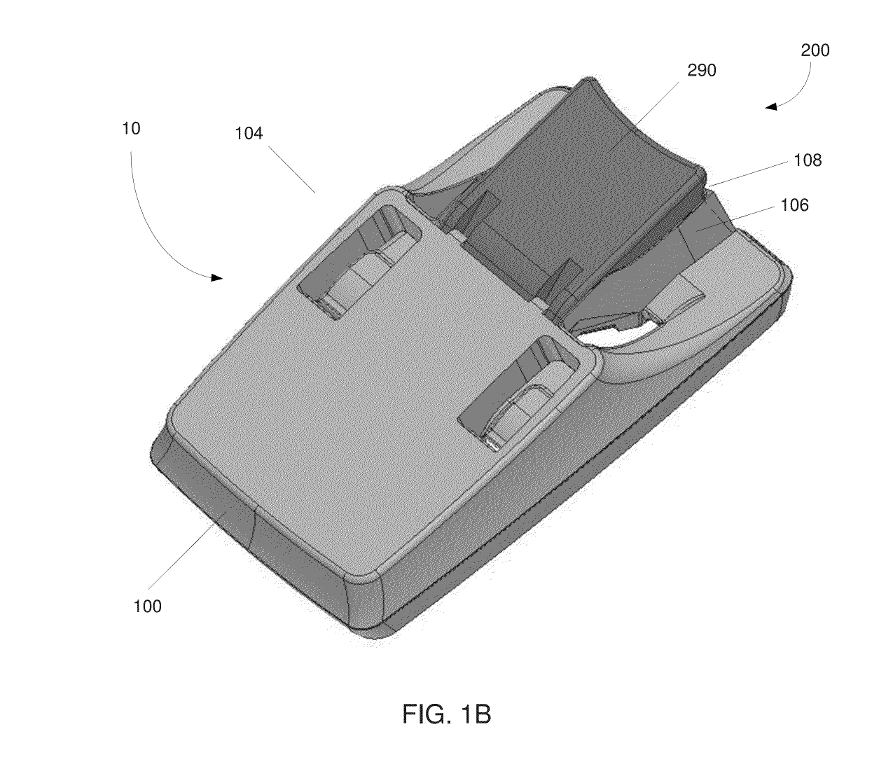

FIGS. 1A-B illustrate top and bottom perspective views, respectively, of a base 10 of a child safety seat in accordance with one embodiment of the disclosure. As shown in this embodiment, the base 10 can comprise two components: a base plate 100 and a height adjustment assembly 200. As shown in this embodiment, the base plate 100 has a top surface 102 configured to receive a car seat or car seat carrier, and a bottom surface 104 configured to face and be secured to the seat of a vehicle, e.g., by use of a LATCH connector or the vehicle's seat belt system. Affixed to the bottom surface 104 of the base plate 100 is a mounting frame 106, which further comprises a front wall 108 disposed at an end of the base 10. The mounting frame 106 can further comprise a passageway or channel for receiving all or portions of the height adjustment assembly 200. The height adjustment assembly 200 is configured to extend outwardly from the bottom surface 104 of the base plate 100. Accordingly, when the base 10 is secured to a vehicle seat, the height adjustment assembly 200 may be used to adjust the height of the base 10 with respect to the seat.

In certain embodiments, the base plate 100 and mounting frame 106 may comprise a single molded plastic component. However, in other embodiments, the base plate 100 may comprise multiple plastic components that are fit or secured together. The base plate 100 can comprise polypropylene or other plastic materials. As shown in this embodiment, the base plate 100 may be formed to have two opposite ends. One end is configured for a child's head and the opposite end is configured for the child's feet. The two edges perpendicular to the ends are referred to as sides.

The height adjustment assembly 200 can comprise an actuator for adjusting the height of the base plate 100. In this embodiment, the actuator comprises a release knob or release button 210. As shown in this embodiment, the release button 210 is visible and accessible from the top surface 102 of the base 10. The release button 210 is configured to actuate an adjustable foot 290, which can be visible on and accessible from the bottom surface 104 of the base 10. Like the base plate 100, some components of the height adjustment assembly 200 may be made from polypropylene or other plastic. The adjustable foot 290 may be disposed in a cavity or gap located on the bottom surface 104 of the base plate 100, for example, as shown in the embodiment of FIG. 1B.

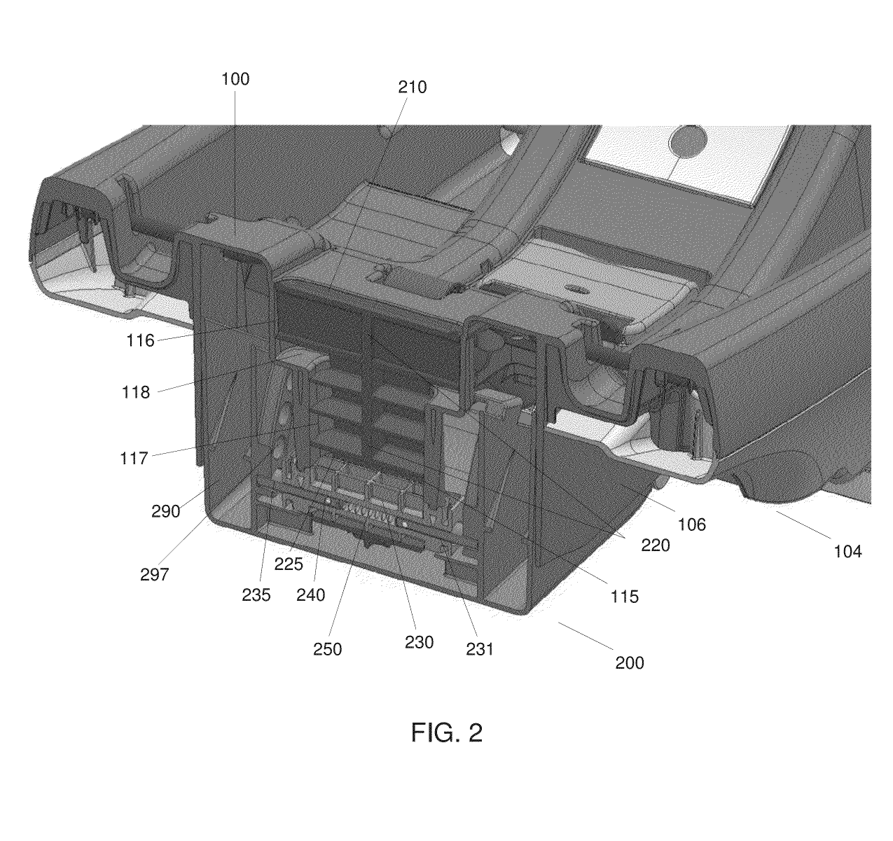

FIG. 2 is a cross-sectional perspective view of the height adjustment assembly 200 taken along line A-A′ of FIGS. 1A, illustrating several components comprising the height adjustment assembly 200. In this embodiment, the height adjustment assembly 200 comprises the release button 210. As shown in the embodiment of FIG. 1A, the release button 210 is disposed on the top surface 102 of the base plate 100. This positioning is beneficial as it is conveniently accessible by a caregiver or end user when the base 10 is installed on a vehicle seat. In this embodiment, the height adjustment assembly 200 is configured to disengage from the adjustable foot 290 when the release button 210 is urged downwards towards the bottom surface 104, thus allowing for free movement of the adjustable foot 290. The release button 210 may be biased towards the top surface 102, such that releasing force on the release button 210 allows the release button 210 to move towards the top surface 102, reengaging with the adjustable foot 290 and preventing further movement.

As shown in this embodiment, the release button 210 may be in communication with or attached to a shaft 220. The shaft 220 has a top portion, which attaches to the release button 210, and a bottom portion which is in communication with a locking pin housing 230. However, in certain embodiments, the release button 210 can comprise the top portion of the shaft 220, such that the shaft 220 and release button 210 are an integral component. The shaft 220 may be hollow or may be a solid component. The shaft 220 can have a width, which can be the dimension between the two sides of the base plate 100. As shown in this embodiment, the top portion of the shaft 220 can be wider than the bottom portion. The shaft 220 can also have a depth, which can be the dimension between the two ends of the base plate 100. Finally, the shaft 220 can have a height, which is the dimension perpendicular to both the width and the depth.

As shown in this embodiment, the shaft 220 can be disposed in a passageway or channel 115 that is part of the mounting frame 106. However, in certain embodiments, the channel 115 may be formed as part of the base plate 100. The channel 115 may be slightly larger than the shaft 220, so that the shaft 220 is able to slide within and be accommodated by the channel 115. In certain embodiments, the channel 115 may be vertical, such that the shaft 220 may move longitudinally between the top and bottom surfaces 102, 104 of the base plate 100. As shown in this embodiment, the channel 115 can further comprise an upper portion 116, a lower portion 117, and a ledge 118. The upper portion 116 is sized to accommodate the top portion of the shaft 220, and the lower portion 117 is sized to accommodate the bottom portion of the shaft 220. The ledge 118 serves to prevent the shaft 220 from overextension downwards, i.e., by contacting the top portion of the shaft 220 when the shaft 220 is sufficiently urged downwards.

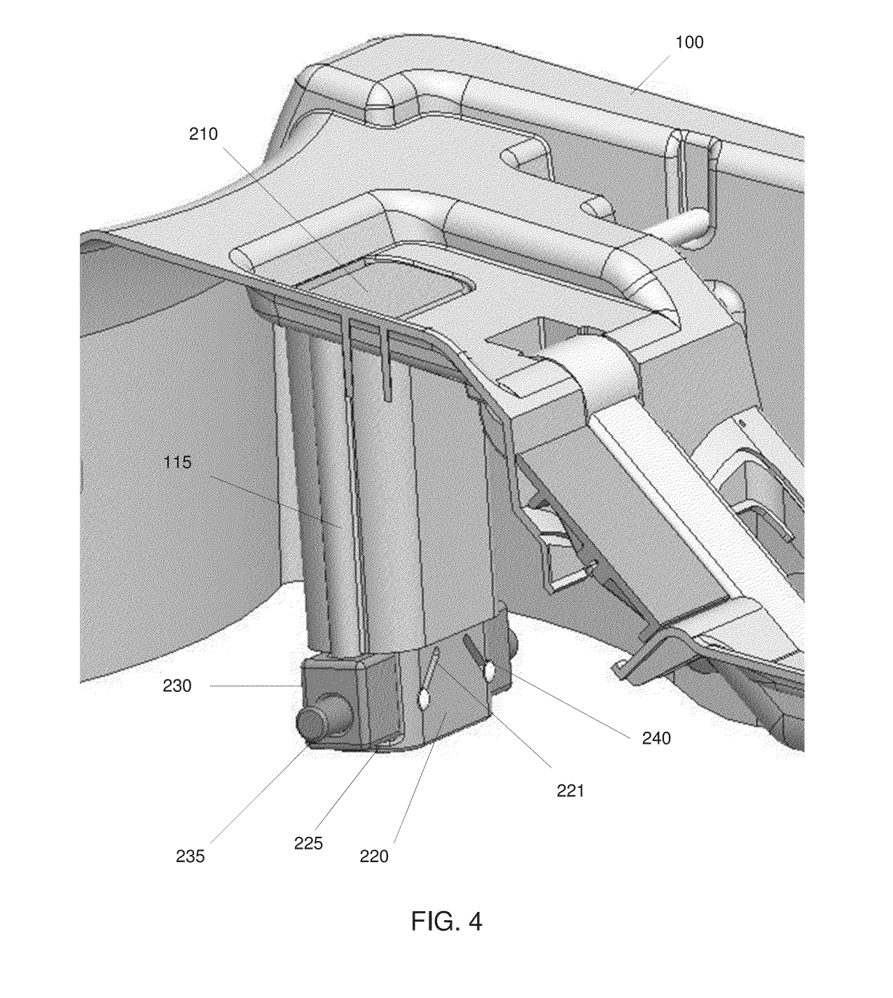

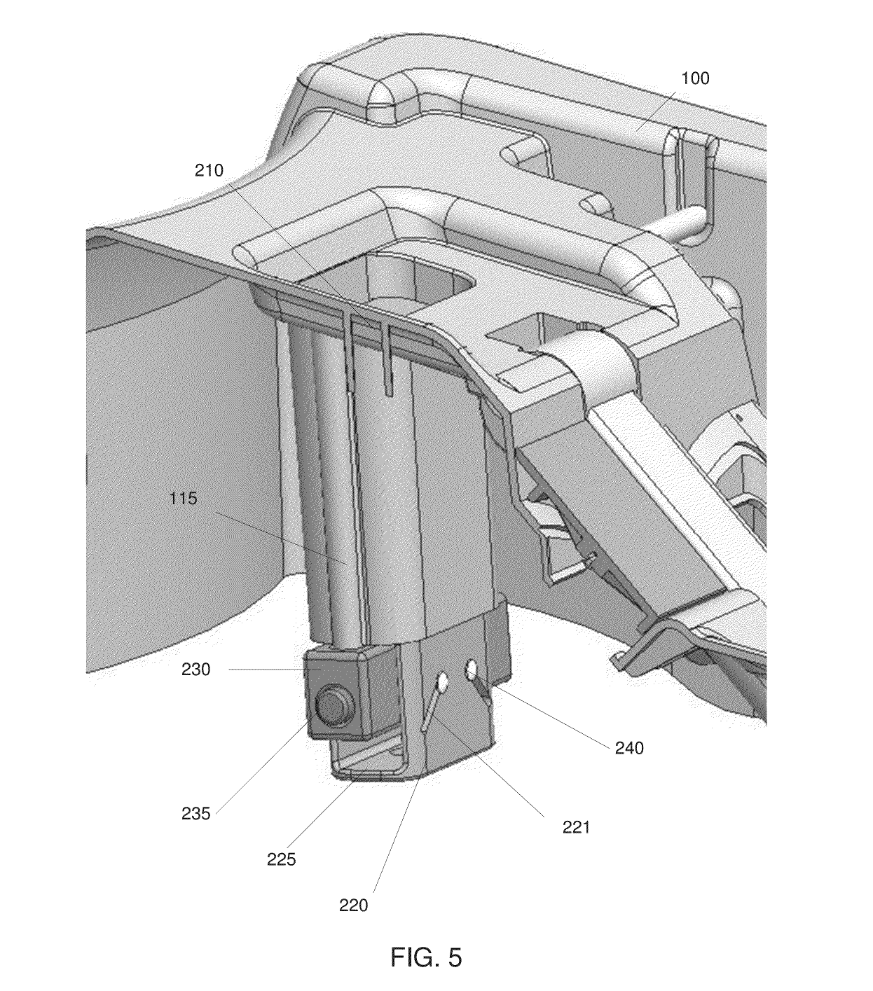

As better seen in FIGS. 4-5, the sides of the bottom portion of the shaft 220 can further comprise an opening 225, through which a locking pin housing 230 is disposed. In this embodiment, the size of the opening 225 exceeds that of the locking pin housing 230 so as to accommodate the locking pin housing 230. In this embodiment, the opening 225 passes through the width of the shaft 220, such that the locking pin housing 230 protrudes outward from the shaft 220 toward the sides of the base plate 100. The locking pin housing 230 may be secured to the lower end of the housing that surrounds the channel 115, such as by screws or other fasteners. Accordingly, in this embodiment, the locking pin housing 230 is secured to the channel 115, and therefore does not move as the shaft 220 traverses the channel 115.

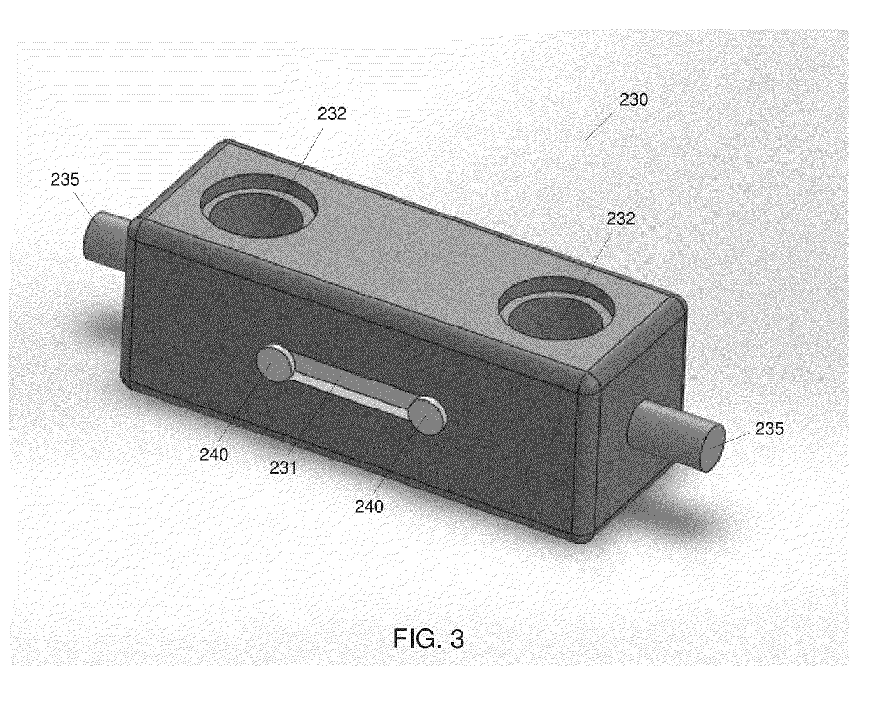

The height adjustment assembly 200 can be configured to translate longitudinal movement of the shaft 220 into lateral movement of one or more retaining members extending from the locking pin housing 230. This causes the one or more retaining members to extend and retract in order to engage and disengage, respectively, from the adjustable foot 290 in response. FIG. 3 illustrates the locking pin housing 230 separated from the height adjustment assembly 200. In this embodiment, the one or more retaining members comprise one or more locking pins 235, which may extend outwardly from opposite ends of the locking pin housing 230 and toward the sides of the base plate 100. The locking pins 235 are each in communication with a respective alignment pin 240, such that the alignment pins 240 are situated perpendicular to the locking pins 235. The locking pin housing 230 may have a horizontal slot 231 on a front surface, such that the alignment pins 240 extend through and slide within the horizontal slot 231 as the locking pins 235 slide within the locking pin housing 230. As will be discussed in more detail below with regards to FIGS. 4-5, the alignment pins 240 extend through the horizontal slot 231 and are further situated within a pair of diagonal slots 221 in the shaft 220, which serve to translate longitudinal movement of the shaft 220 into lateral movement of the locking pins 235.

Also shown in the embodiment of FIG. 3 are two apertures 232. In this embodiment, the apertures 232 may be used to secure the locking pin housing 230 to the bottom section of the channel 115. This may be accomplished, for example, by use of a screw, bolt, rivet, or other equivalent means placed through the apertures 232 and in contact with the bottom section of the channel 115 (e.g., as shown in FIGS. 4-5.).

Referring back to FIG. 2, as shown in this embodiment, the locking pins 235 are separated by and in communication with a locking pin biasing member 250. The locking pin biasing member 250, which may be a spring, serves to bias the locking pins 235 outwardly toward the sides of the base plate 100 such that each locking pin 235 enters or is received by one or more locking members, such as one of a plurality of recesses 297 formed into the adjustable foot 290. Additionally, the locking pin biasing member 250 can also bias the release button 210 and shaft 220 towards the top surface 102 of the base plate 100, due to the translation of lateral movement of the locking pins 235 to longitudinal movement of the shaft 220.

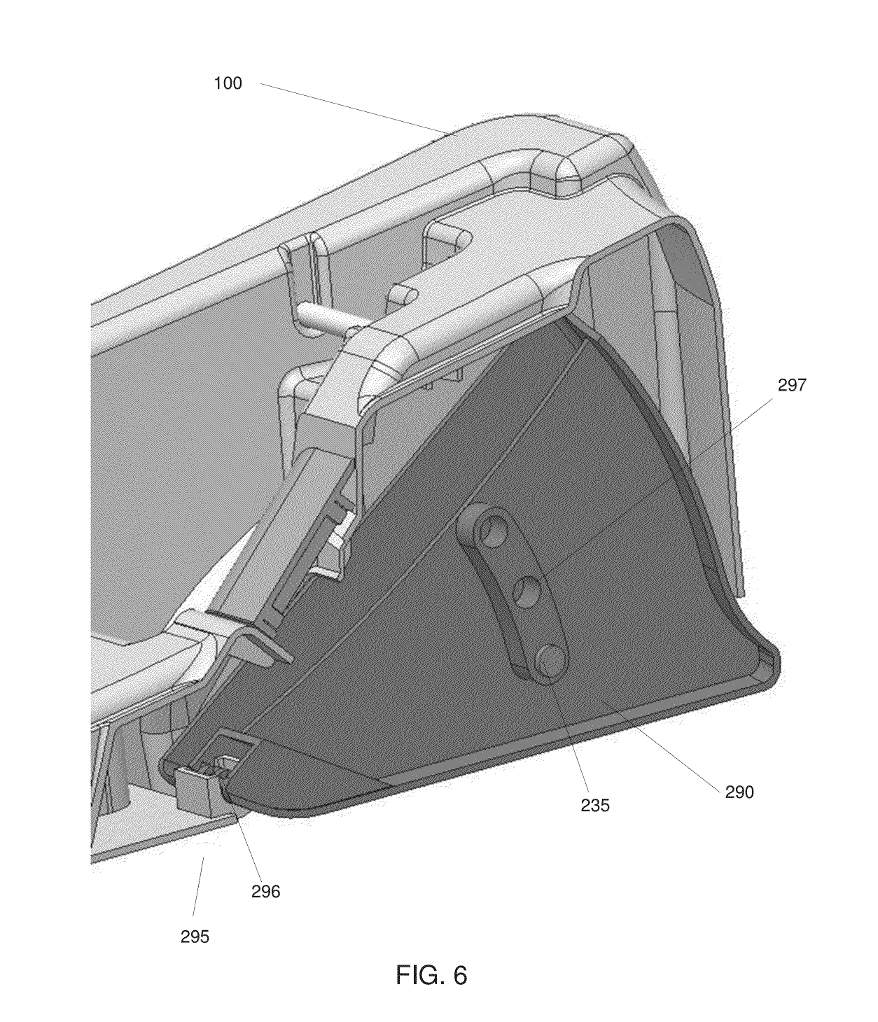

The adjustable foot 290 can be disposed in a gap between the front wall 108 of the mounting frame 106 (e.g., as shown in FIG. 1B) and a wall on the bottom surface 104 of the base plate 100. The adjustable foot 290 is configured such that it can extend down and away from, or up and towards, the base plate 100. The adjustable foot 290 further comprises a locking member that receives, retains, cooperates with, or otherwise communicates with the retaining members (e.g., the locking pins 235) of the shaft 220. In this embodiment, the locking member comprises a plurality of recesses 297 (as shown in FIG. 6) accessible on an inner surface of the adjustable foot 290. When the locking pin 235 enters a recess 297, movement of the adjustable foot 290 is arrested. When the locking pin 235 exits the recess 297, the adjustable foot 290 again becomes movable. While in this embodiment, the locking member is position on an inner surface of the adjustable foot 290, in certain embodiments the locking member or plurality of recesses can be positioned on various surfaces of the adjustable foot 290. Further, in certain embodiments, an adjustable foot 290 according to the disclosure may also pivot with respect to the base plate 100.

FIGS. 4-5 illustrate the height adjustment assembly 200 in the locked and unlocked positions, respectively, with the adjustable foot 290 removed. As shown in this embodiment, the exterior of the shaft 220 can comprise a plurality of diagonal slots 221. The plurality of diagonal slots 221 are disposed near the distal end of the shaft 220. The alignment pins 240 extend through the horizontal slots 231 in the locking pin housing 230 (as shown in the embodiment of FIG. 2) and through the diagonal slots 221 in the shaft 220. As shown in this embodiment, the diagonal slots 221 may be oriented in the form of an inverted “V” shape, although the two slots in this embodiment do not touch. Stated differently, the diagonal slots 221 are oriented downward and outward away from the base plate 100. The diagonal slots 221 serve to translate longitudinal movement of the shaft 220 into lateral movement of the locking pins 235 via the alignment pins 240 by tracking the alignment pins 240 within the diagonal slots 221.

In the locked position, as shown in FIG. 4, the release button 210 is in its upper position, which may be flush with the upper surface of the base plate 100. The shaft 220 is in its uppermost position, and the alignment pins 240 of the locking pin housing 230 are pushed outward by the diagonal slots 221 in the shaft 220. Since the alignment pins 240 are pushed outward, the locking pins 235 are likewise pushed outward. The locking pin biasing member 250 (e.g., as shown in FIG. 2) provides sufficient force to ensure that the locking pins 235 remain outwardly extended, with the alignment pins 240 positioned at the lower and outer portion of the diagonal slots 221. With the alignment pins 240 in this position, the release button 210 may be flush with the upper surface of the base plate 100.

FIG. 5 illustrates the height adjustment assembly 200 in the unlocked position. In this position, the release button 210 has been urged downward against the force of the locking pin biasing member 250. This causes the shaft 220 to move downward over the locking pin housing 230, resulting in the alignment pins 240 moving inward towards the center of the shaft 220, thus following the path of the diagonal slots 221. This action also serves to move the locking pins 235 inward against the force of the locking pin biasing member 250, causing the locking pin 235 to exit the recess 297 in the adjustable foot 290 (e.g., as shown in FIG. 2). Thus, the adjustable foot 290 becomes movable while the release button 210 is pressed downward due to the disengagement between the locking pins 235 and recesses 297.

In use, an operator or caregiver may then allow the adjustable foot 290 to move to a desired position to achieve a desired height of the base plate 100. For example, this height may be that required to place the base plate 100 in a level configuration with respect to the vehicle seat to which the base plate 100 is attached. Once a desired position and height have been achieved, the release button 210 may then be released. This action results in the locking pin biasing member 250 urging the locking pins 235 to extend outwards, so that the alignment pins 240 slide through the horizontal slots 231 of the locking pin housing 230 and the diagonal slots 221 of the shaft 220. Thus, the shaft 220 and release button 210 are returned to their biased and locked position, as shown in FIG. 4.

FIG. 6 illustrates a cross-section of the adjustable foot 290. As shown in this embodiment, the adjustable foot 290 may be attached to the base plate 100 at a pivot point 295 such that it is pivotable about the pivot point 295. As shown in the embodiment of FIG. 6, the pivot point 295 can comprise a rod 296 extending from the adjustable foot 290 and inserted into an aperture in the base plate 100. In another embodiment, the adjustable foot 290 may have an aperture, through which the rod 296 is disposed.

As described above, the adjustable foot 290 comprises a plurality of recesses 297 which can be aligned with the locking pins 235. While FIG. 6 shows three such recesses 297, the number is not limited by this disclosure. For example, in certain embodiments, an adjustable foot according to the disclosure may comprise 1, 2, 4, 5, 6, etc. recesses 297. When in the locked position, the locking pin 235 extends into one of these recesses 297, thereby arresting movement of the adjustable foot 290 and defining or holding the height of the base plate 100 at a first height position. When in the unlocked position, the locking pins 235 are retracted, and the adjustable foot 290 can be rotated about the pivot point 295. When the adjustable foot 290 is moved to the desired position, such as a second height position, the release button 210 is released, and the locking pins 235 extend outward, capable of being captured in one of the recesses 297. If the adjustable foot 290 is disposed such that the recesses 297 are not aligned with the locking pins 235, the adjustable foot 290 can pivot until the locking pins 235 are captured by the nearest recess 297. Thus, the plurality of recesses 297 and locking pins 235 allow the adjustable foot 290 to be held in a variety of height positions.

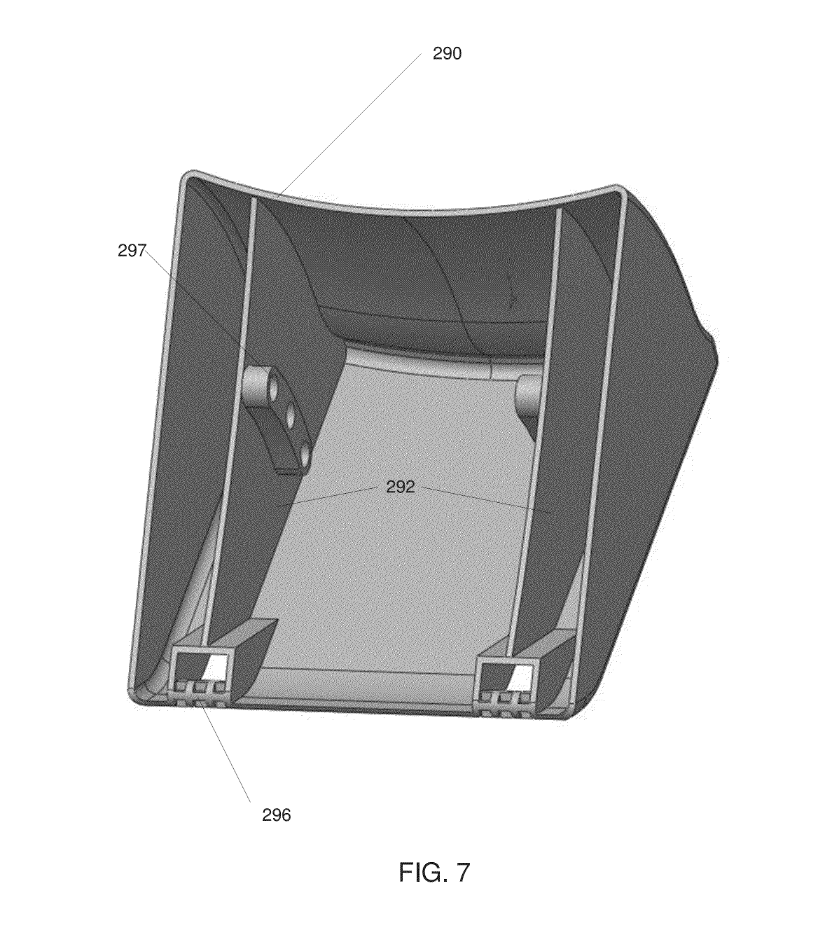

FIG. 7 illustrates a perspective view of the adjustable foot 290 separated from the base plate 100. As shown, a plurality of recesses 297 is disposed on a pair of opposite interior walls 292 of the adjustable foot 290. These recesses 297 correspond to the locking pins 235 (e.g., the locking pins 235 of FIG. 2). It should be noted that in this embodiment, the pattern of recesses 297 forms an arcuate path, thus accommodating the rotation of the adjustable foot 290, as it is pivoted about pivot point 295. Further, while the plurality of recesses 297 is disposed on a pair of opposite interior walls 292 of the adjustable foot 290, certain embodiments of the disclosure may comprise a plurality of recesses disposed on external walls of an adjustable foot.

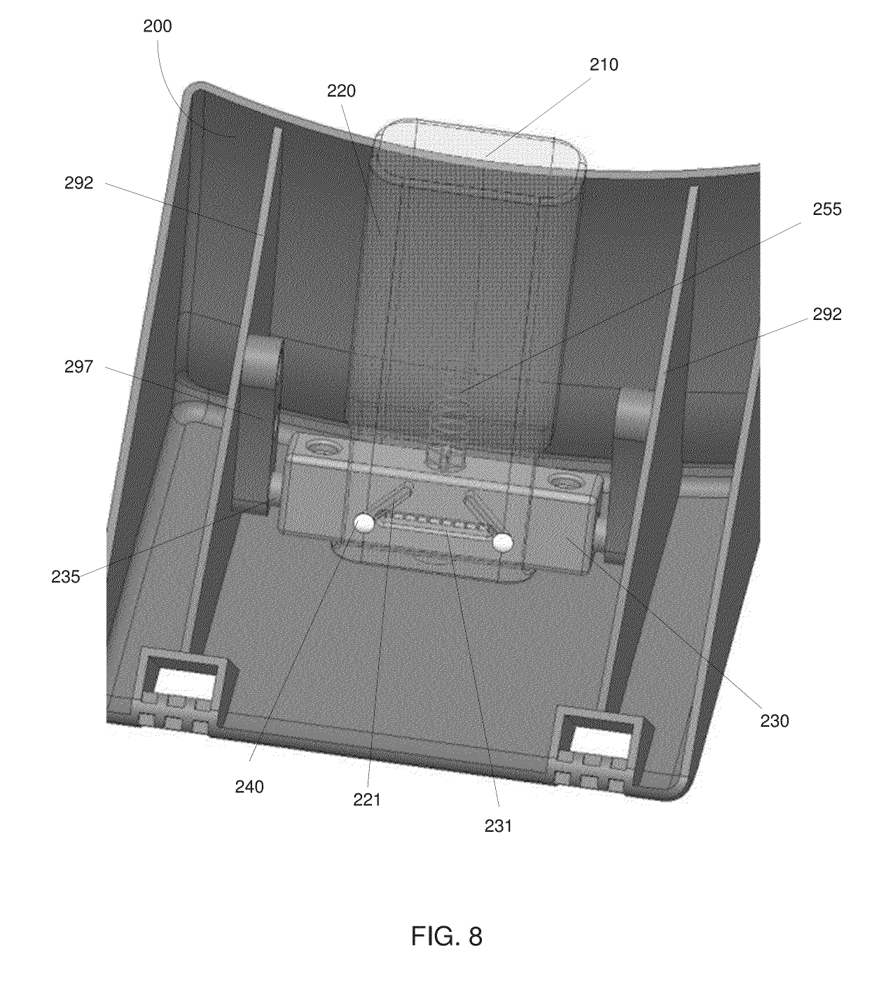

FIG. 8 illustrates another embodiment of a height adjustment assembly 200 according to the disclosure that uses an auxiliary biasing member 255, which may either supplement or replace the locking pin biasing member 250. In this view, the base plate 100 and channel 115 are not shown, and the shaft 220 is displayed as semi-transparent to further illustrate components of the locking pin housing 230. The auxiliary biasing member 255 is in communication with the locking pin housing 230 and an interior surface of the shaft 220, and serves to bias the shaft 220 and release button 210 to the locked position, as shown. As the release button 210 is pressed downwards, the shaft 220 moves downwards over the locking pin housing 230, causing the alignment pins 240 to traverse the diagonal slots 221 and horizontal slots 231. The locking pins 235 retreat inwardly and are released from the recess 297, allowing free movement of the adjustable foot 290 and placing the height adjustment assembly 200 in the unlocked position. When the downward force applied to the release button 210 is released, the auxiliary biasing member 255 biases the shaft 220 and release button 210 upwards, causing the locking pins 235 to extend outwardly and enter the recess 297, thus placing the height adjustment assembly 200 into the locked position. The auxiliary biasing member 255 may be used in place of the locking pin biasing member 250, or alternately may be used to supplement the locking pin biasing member 250 to provide additional force.

Further, it should be noted that the present disclosure is not limited to embodiments having only a single set of locking pins 235. For example, in another embodiment the locking pin housing 230 may feature multiple sets of locking pins 235. In this embodiment, the height adjustment assembly 200 may have only a single set of recesses 297. Thus, the desired height of the height adjustment assembly 200 is set by placing one set of the locking pins 235 into the single set of recesses 297. Further variations of locking pins 235 and recesses 297 may be evident to those having skill in the art.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A base for a child safety seat, adapted to be mounted to a vehicle seat, comprising:
a base plate having a top surface and a bottom surface, the top surface configured to receive a car seat and the bottom surface adapted to face toward said vehicle seat, wherein a cavity is disposed in said bottom surface; and
a height adjustment assembly, comprising:
an actuator;
a shaft having a first end attached to said actuator, and a retaining member disposed on said shaft; and
an adjustable foot adapted to be disposed in said cavity and having a locking member on an inner surface;
wherein said shaft has a locked position, wherein said retaining member extends from said shaft and cooperates with said locking member to hold said adjustable foot in a first height position, and an unlocked position where said retaining member retracts from said locking member allowing free movement of the adjustable foot.

2. The base for a child safety seat of claim 1, wherein the actuator is accessible from the top surface of the base plate.

3. The base for a child safety seat of claim 1, further comprising one or more additional locking members disposed on said inner surface, wherein said one or more additional locking members allow said adjustable foot to be held in a variety of height positions.

4. The base for a child safety seat of claim 1, further comprising one or more additional retaining members disposed on said shaft, wherein said one or more additional retaining members allow said adjustable foot to be held in a variety of height positions.

5. The base for a child safety seat of claim 1, further comprising a biasing member in communication with said retaining member, wherein said biasing member is configured to bias said shaft to said locked position.

6. The base for a child safety seat of claim 1, wherein said retaining member comprises a pin.

7. The base for a child safety seat of claim 6, wherein said locking member comprises a recess configured to receive said pin.

8. A base for a child safety seat, comprising:
a base plate comprising:
an upper surface configured to securely receive a car seat carrier; and
a lower surface adapted to be positioned on a vehicle seat;
a shaft positioned within the base and in communication with a retaining member, wherein the base is configured to translate longitudinal movement of the shaft into lateral movement of the retaining member; and
a foot disposed on the lower surface, wherein lateral movement of the retaining member is used to releasably engage the foot.

9. The base of claim 8, wherein the lower surface further comprises a cavity, wherein the foot is at least partially disposed within the cavity.

10. The base of claim 8, wherein the foot is configured to move longitudinally to adjust the height of the base with respect to the seat of the vehicle.

11. The base of claim 10, wherein the foot is in contact with the vehicle seat.

12. The base of claim 8, wherein the base further comprises an actuator disposed on the upper surface, wherein the actuator is in communication with the shaft.

13. The base of claim 12, wherein the base is configured to translate longitudinal movement of the actuator into lateral movement of the retaining member.

14. The base of claim 8, wherein the foot further comprises a locking member, wherein lateral movement of the retaining member secures the foot by engaging with the locking member.

15. The base of claim 8, wherein the retaining member comprises a locking pin in communication with an alignment pin, and the base further comprises a diagonal slot, wherein the base is configured to translate longitudinal movement of the shaft into lateral movement of the retaining member by tracking the alignment pin within the diagonal slot.

16. The base of claim 8, wherein the retaining member is biased towards engagement with the foot.

17. The base of claim 8, wherein the foot is pivotally attached to the lower surface of the base.

18. A base for a child safety seat, adapted to be mounted in a vehicle seat, comprising:
a base plate having a top surface and a bottom surface, the top surface configured to receive a car seat carrier and the bottom surface adapted to face toward the vehicle seat, wherein a cavity is disposed in the bottom surface; and
a height adjustment assembly, comprising:
an actuator;
a shaft having a first end attached to the actuator, and a retaining member disposed on the shaft; and
an adjustable foot adapted to be disposed in the cavity and having a locking member;
wherein the shaft has a locked position, wherein the retaining member cooperates with the locking member to hold the adjustable foot in a first height position, and an unlocked position wherein the retaining member retracts from the locking member to allow free movement of the adjustable foot;
wherein the base is configured to translate longitudinal movement of the shaft into lateral movement of the retaining member.

19. The base of claim 18, wherein the retaining member comprises a plurality of retaining members.

20. The base of claim 18, wherein the locking member comprises a plurality of locking members.
